(19) United States
(12) Patent Application Publication
(10) Pub. No.: US 2008/0294647 A1
(43) Pub. Date: Nov. 27, 2008

(54) METHODS AND APPARATUS TO MONITOR CONTENT DISTRIBUTED BY THE INTERNET

(76) Inventor: Arun Ramaswamy, Tampa, FL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/032,519

(22) Filed: Feb. 15, 2008

Related U.S. Application Data
(60) Provisional application No. 60/939,341, filed on May 21, 2007.

(51) Int. Cl. G06F 17/30

(52) U.S. Cl. 707/10; 707/E17.032

(57) ABSTRACT

Methods and apparatus to monitor content distributed by the Internet are disclosed. An example method includes requesting a really simply syndication (RSS) feed file associated with a received topic identification, receiving the RSS feed file identifying a first media content, extracting a first resource identifier for the first media content from the RSS feed file, retrieving the first media content using the first resource identifier, at least one of extracting a first content identification code from the first media content and generating a first signature for the first media content, and storing at least one of the first content identification code and the first signature in a memory.

### FIELD OF THE DISCLOSURE

The present disclosure pertains to monitoring media content distribution and, more particularly, to methods and apparatus to monitor content distributed by the Internet.

### BACKGROUND

As Internet websites have grown in size and complexity, and the frequency of updates to webpages has increased, website creators have developed methods and techniques for enabling users of the websites to be informed of information and content available at the website. One technique that website creators have used is a content feed. A content feed is a file or files that includes a summary of content available at a website and links to the full version of the content available at the website. One type of content feed is known as really simple syndication (RSS). An RSS document is an extensible markup language (XML) file that is built according to standards established for RSS feeds. By following RSS standards, a website creator can ensure that their content feed can be read by any type of client that supports the RSS standards.

For example, a user of a website that is interested in staying informed of changes at a website can subscribe to a content feed (e.g., tell the user's content feed reader to automatically-periodically retrieve the content feed from the remote site and alert the user) and/or can retrieve the content feed manually. If updates to the webpage have been made since the last time that the content feed was retrieved, the user is alerted. The user can review the information in the content feed (e.g., descriptions of information and/or media content available at the website) and can instruct a content feed reader to retrieve the full content from a location identified in the content feed and/or can request the users web browser to display the full content.

### BRIEF DESCRIPTION OF THE DRAWINGS

FIG. 1 is a block diagram of an example system in which a site monitor detects and/or identifies media content available at remote sites.

FIG. 2 is a block diagram of an example implementation of the site monitor of FIG. 1.

FIG. 3 is a flowchart representative of example machine readable instructions that may be executed to implement the site monitor of FIGS. 1 and 2.

FIG. 4 is a flowchart representative of example machine readable instructions that may be executed to implement the site monitor of FIGS. 1 and 2.

FIG. 5 is a flowchart representative of example machine readable instructions that may be executed to implement the site monitor of FIGS. 1 and 2.

FIG. 6 is an illustration of an example content feed file that is in XML format.

FIG. 7 is a block diagram of an example computer platform capable of executing the machine readable instructions illustrated in FIGS. 3-5 to implement the apparatus and/or methods disclosed herein.

### DETAILED DESCRIPTION

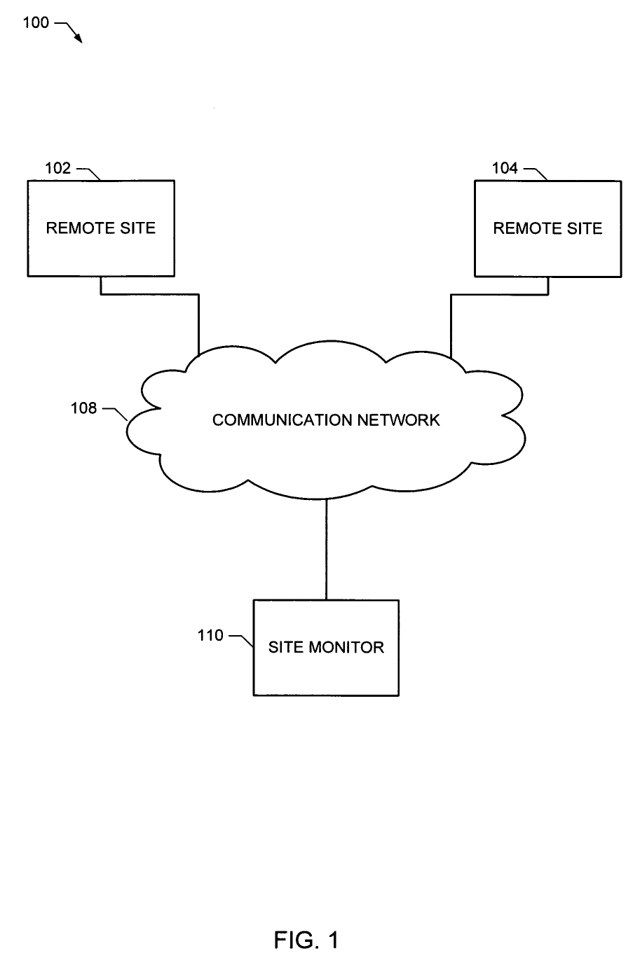

FIG. 1 is a block diagram of an example system 100 in which a site monitor 110 detects and/or identifies media content available at remote sites 102 and 104. The example system 100 may be used, for example, to detect copyright violations. In an example implementation, the site monitor 110 subscribes to a media content feed (e.g., a syndication feed) of one or more of the remote sites 102 and 104. The example media content feed provides, among other things, one or more universal resource locator(s) (URL(s)) for media content available at the remote sites 102 and 104. For example, at periodic intervals (e.g., once a week), the remote sites 102 and 104 may send and/or the site monitor may request and receive an extensible markup language (XML) file identifying all media content that is new to the respective remote site 102 or 104 since the last XML file was sent. The example site monitor 110 receives the media content feed(s) from the remote site(s) 102 and/or 104 and extracts URL(s) for desired entries. For example, a user may input one or more keyword(s) or phrase(s) to the site monitor 110. The site monitor 110 will, thus, only extract URLs for content that is associated with the keyword(s) or phrase(s). The site monitor 110 retrieves the media content for extracted URLs and extracts any program identifier codes associated with the media content and/or generates a signature (e.g., a signal or character string representative of one or more characteristics of the media content )for each one of the retrieved media content. The example site monitor 110 compares the extracted code and/or generated signature to a database of references codes and/or reference signature(s) for known media content. If the example site monitor 110 determines that the extracted code and/or generated signature for any of the retrieved content matches a corresponding reference code and/or reference signature in the database, the identity of the content and/or its original source (which may be different from the remote sites 102 and 104 providing the content) are thus identified and the example site monitor records the fact that the respective remote site (i.e., one of the remote sites 102 and 104) is distributing the known media content. If the known media content is copyrighted media content, the example site monitor 110 may send a copyright violation notice to the original source of the media content and/or to the distributing source (e.g., the remote sites 102 and/or 104).

The example system 100 of FIG. 1 includes the remote site 102, the remote site 104, the communication network 108, and the site monitor 110. While three remote sites, one network, and one site monitor are included in the example system 100, other implementations of the system 100 may include any number of remote sites, networks, and site monitors. For example, a separate site monitor may be included for each remote site or for corresponding groups of remote sites.

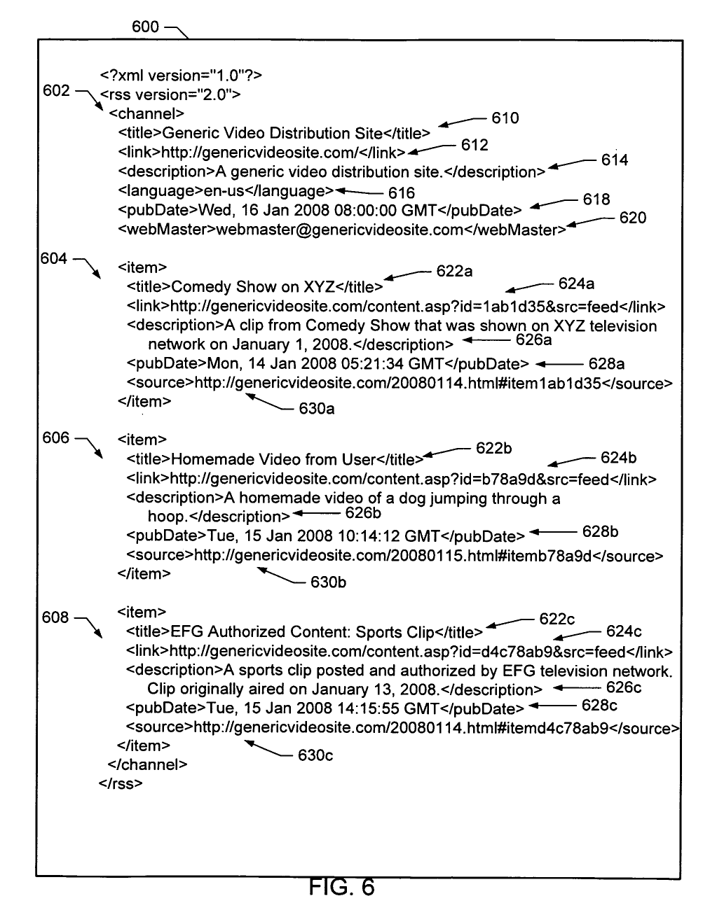

The remote site 102 and the remote site 104 of the illustrated example are network servers that output a content feed identifying content available at the respective remote site. In particular, the remote site 102 of the illustrated example outputs an XML file (e.g., the XML file illustrated in FIG. 6) in response to a request for content associated with a topic identification (e.g., a keyword, a phrase, etc.). For example, assuming that the remote site has content related to television networks such as NBC and/or ABC, when a user (e.g., a person or the site monitor 110) of the remote site 102 sends a request for content associated with the television network NBC, the remote site 102 sends an XML file identifying media content available at the remote site 102 that is associated with NBC. In contrast, the remote site 104 of the illustrated example allows a user to subscribe to automatically receive a content feed. While the example remote site 102 and the example remote site 104 are implemented to handle the content feed differently, the system 100 may include any number of remote sites that are implemented to send a content feed in response to a request and any number of remote sites that are implemented to send a content feed based on a subscription. In addition, a remote site may send content feeds using any other technique.

The example XML file sent by the example remote site 102 includes information about and an address (e.g., a URL) for the remote site 102 and a title, a description, an address (e.g., a URL), a publication date, and a parent webpage (e.g., a URL) for each one of the media content (e.g., a webpage, a video file or stream, an audio file or stream, a text file, a multimedia presentation, etc.) available at the remote site 102. Alternatively, the XML file may include any subset of the previous information and/or may include additional information such as, for example, the author of the content, a user that uploaded the content, a date the content was created, etc.

The example remote site 104 periodically sends an XML file identifying content to users, devices, and/or systems that have subscribed to the content feed. For example, if a user subscribes to a “newly added” content feed, the remote site 104 will periodically transmit an XML file identifying content that has been added since the previous transmission. The remote site 104 may include any number and/or types of content feeds. For example, the remote site 104 may allow users to identify topic(s) of media content to be periodically identified in an XML file. While the example remote site 104 transmits the XML file periodically, the XML file may be transmitted according to any schedule such as, for example, when new content is added, at a particular time or date as specified by a schedule, when a user requests that the file is transmitted, when a certain minimum amount of media content associated with the transmission has been located, etc. In addition, while the example remote site 104 transmits an XML file, any other type of file may be used such as, for example, a delimited text file, a Microsoft® Excel® file, a hyper-text markup language (HTML) file, etc.

The remote site 102 and the remote site 104 may be any type of remote site. In the illustrated example, the remote site 102 and the remote site 104 are servers on the Internet. For example, the remote site 102 and/or the remote site 104 may be one of the YouTube™ website or any other website which accepts user submitted content. However, the remote site 102 and the remote site 104 may alternatively be any type of server on any type of network.

The communication network 108 of the illustrated example is a wide area network that communicatively couples the remote site 102, the remote site 104, and the site monitor 110. For example, the communication network 108 may be the Internet and each of the remote site 102, the remote site 104, and the site monitor 110 may include devices and/or subscribe to services that enable the components to communicate via the Internet. Alternatively, any other type of network may implement the communication network 108. For example, the communication network may be any type of local area network, wide area network, wireless network, wired network, etc. In addition, the communication network 108 may be implemented by one or more separate or interconnected networks. For example, the remote site 102 may be communicatively coupled to the site monitor 110 via a separate network than a network communicatively coupling the remote site 104 and the site monitor 110.

The site monitor 110 of the illustrated example requests a content feed (e.g., syndication feed, an RSS feed, etc.) and/or subscribes to a content feed and, periodically, receives a content feed from the remote site 102 and/or the remote site 104. The example site monitor 110 of FIG. 1 automatically parses the content feed to extract an address or identifier for retrieving content, retrieves the content, and extracts and/or generates identifying information from the media content. The site monitor 110 compares the extracted and/or generated identifying information (e.g., a program identification code in the audio and/or video, a signature (audio and/or video), etc.) to reference identifying information (e.g., identifying information for known media content) to identifying the media content (e.g., by determining that the media content is the same or substantially similar to reference media content). The example site monitor 110 stores identifying information in a database and computes metrics for the identified media content. For example, the site monitor 110 may compute the number of instances where media content from a particular remote site was substantially similar to reference media content. The site monitor 110 may additionally or alternatively send a notification regarding whether or not media content matched referenced media content. For example, if the reference media content is known to be copyrighted media content, the site monitor 110 may send a notification (e.g., an email) to the remote site that is distributing the media content, a user of the remote site (e.g., a user that uploaded the media content to the remote site), an owner of the copyright for reference media content, and/or a copyright enforcement entity (e.g., a law firm, a law enforcement agency, a government agency, a private investigative agency, etc.).

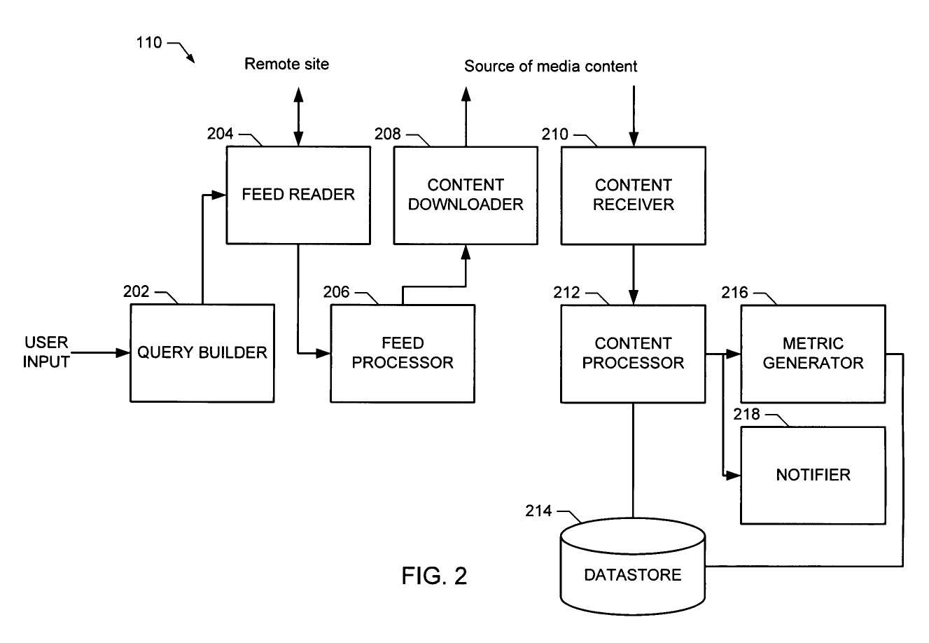

FIG. 2 is a block diagram of an example implementation of the example site monitor 110 of FIG. 1. The example site monitor 110 of FIG. 2 includes a query builder 202, a feed reader 204, a feed processor 206, a content downloader 208, a content receiver 210, a content processor 212, a datastore 214, a metric generator 216, and a notifier 218.

The query builder 202 of the illustrated example receives a topic identification from a user of the site monitor 110 and sends the topic identification to the feed reader 204. The topic identification of the illustrated example is any type of keyword(s) or phrase(s). For example, a user interested in analyzing content associated with a media content producer, may input that producer's name. A user interested in analyzing content associated with a particular subject (e.g., basketball, football, the Super Bowl®, the World Series, a book, etc.) may input a keyword or phrase associated with the particular subject. A user interested in analyzing content encoded or created by particular software may input the name of the software. In other words, any keyword and/or phrase may be used to limit the analysis of the site monitor 110 to a particular topic. Alternatively, no keyword or phrase may be received if the site monitor 110 includes one or more stored keyword(s) or phrase(s) or the site monitor 110 is to analyze all content available at a remote site.

The query builder 202 of the illustrated example also receives one or more identifications (e.g., URLs) of remote sites (e.g., remote site 102 and remote site 104 of FIG. 1) that should be monitored or queried. Alternatively, the query builder 202 may include a list of predetermined remote sites, may automatically determine relevant remote sites based on the received topic identification, may query all available remote sites, etc. The query builder 202 transmits received remote site identifications to the feed reader 204.

The feed reader 204 of the illustrated example subscribes to and/or requests a content feed from a remote site identified by the query builder 202 (e.g., the remote site 202 or the remote site 204) and receives the content feed from the remote site (e.g., the remote site 202 or the remote site 204). The example feed reader 204 requests the content feed and/or subscribes to the content feed based on the topic information received from the query builder 202. When a remote site (e.g., the remote site 202 or the remote site 204) transmits a content feed to the site monitor 110, the feed reader 204 receives the content feed (e.g., an XML file) and transmits the content feed to the feed processor 206.

The feed processor 206 of the illustrated example receives a content feed from the feed reader 204 and extracts any address(es) for retrieving media content identified in the content feed. For example, the feed processor 206 of the illustrated example extracts one or more URLs from the XML content feed file. The feed processor 206 may additionally receive a topic identification from a query builder 202 via the feed reader 204, and may selectively extract one or more address(es) for content that is associated with the topic identification (e.g., may extract address(es) for entri(es) in the content feed having a description (e.g., text included in the XML content feed file) that includes a keyword and/or phrase from the topic identification). The example feed processor 206 transmits the extracted address(es) to the content downloader 208.

The example content downloader 208 of FIG. 2 receives one or more addresses from the feed processor 206 and requests transmission of the media content from the location(s) specified by the address(es). In the illustrated example, the address(es) specify remote site 102 or 104 that transmitted the content feed to the site monitor 110. Alternatively, the address(es) may specify a site different from the site that transmitted the content feed to the site monitor 110. The content downloader 208 of the illustrated example may request media content one at a time. Alternatively, any type of downloading technique may be used such as, for example, requesting more than one media content in parallel, requesting media content using a peer-to-peer downloading technique (e.g., a BitTorrent™ client), etc.

The content receiver 210 of the illustrated example receives media content transmitted to the site monitor 110 in response to requests from the content downloader 208. In the illustrated example, the content receiver 210 receives one piece of media content at time. However, like the content downloader 208, the content receiver 210 may receive media content using any type of downloading or streaming technique. The content receiver 210 transmits received media content to the content processor 212. For example, portions of media content (e.g., streaming media content) may be transmitted to the content processor 212 prior to receipt of the entirety of the media content.

The content processor 212 of the illustrated example receives media content from the content receiver 210 and processes the media content to produce identifying information. The example content processor 212 extracts embedded program identification codes and/or generates a signature for the media content. In other words, the content processor 212 may extract a code (e.g., an audio code, a video code, a packet identification (PID) header, or other identifier), may generate a signature (e.g., a preferably unique representation of some aspect of the content or the signal representing the content), and/or may extract a code and generate a signature. Additionally, the content processor 212 may obtain identifying information in any other way such as, for example, by extracting metadata included with the media content, by retrieving information associated with the media content from a remote site (e.g., the remote site 102 and/or the remote site 104 of FIG. 1), etc.

The content processor 212 of the illustrated example compares the obtained identifying information with reference identifying information retrieved from the datastore 214 to determine the identity of the media content. For example, the content processor 212 compares a signature generated from the received media content to signatures stored in the datastore 214 that are associated with known media content. If signatures can be matched, the content processor 212 identifies the received media content as the known media content associated with the reference signature. The content processor 212 additionally or alternatively compares an extracted program and/or source identification code to codes stored in the datastore 214. When an extracted code matches a code stored in the datastore 214, the content processor 212 identified the received media content as the known media content associated with the stored (reference) code. While the example content processor 212 of FIG. 2 uses either the comparison of signatures or the comparison of codes to identify the media content (e.g., the comparison of signatures is used if no code is detected or matched), the content processor 212 may alternatively use both comparisons and identify the media content as uncertain if the two comparisons do not yield the same result or may use a weighting algorithm to determine the most likely correct identifying information.

The example content processor 212 sends the obtained identifying information and/or the information obtained from the comparison of the code and/or signature to the datastore 214 for storage. In addition, the content processor 212 transmits the identifying information to the metric generator 216 and the notifier 218.

The datastore 214 of the illustrated example is a database including a first table for storing information associated with received media content and a second table for storing information associated with reference (i.e., known) media content. Alternatively, the datastore 214 may be implemented by any other type of datastore such as, for example, files stored on a memory device.

The metric generator 216 of the illustrated example receives information identifying media content from the content processor 212 and uses the information to generate metrics regarding consumption of media content. For example, the metric generator 216 may track the number of times that media content from a particular remote site is matched to reference data. For example, when the reference data is copyrighted media content, the metric generator 216 may increment a counter associated with that content and/or with the owner of the copyrighted material to count how many instances of media content at a remote site likely infringe the copyright(s) of the copyright owner. In another example, the metric generator 216 may indicate the popularity of particular media content by determining the number of times that the media content is found at one or more remote sites. The metric generator 216 may send the generated metrics to the datastore 214 for storage and/or may transmit the metrics to the notifier 218 for notification of interested parties (e.g., the copyright holder).

The notifier 218 of the illustrated example receives information associated with media content received at the site monitor 110 and information indicating whether the media content was matched to reference media content. In response, the example notifier 218 transmits notification(s) to interested parties. For example, the notifier 218 of the illustrated example automatically transmits a notification to the remote site from which the media content was received. When the received media content is compared with reference media content that is copyrighted, the notification may be a copyright violation notice requesting that the media content be removed. When the remote site allows users to upload media content to the remote site, the notifier 218 may additionally or alternatively transmit a notification to the user that uploaded the media content. Additionally or alternatively, the notifier 218 may transmit a notification to any other party (e.g., the copyright owner, a copyright enforcement entity, an intellectual property law firm or attorney, etc.). Further, the notification may be in any format. For example, the message may be a plain text notification that includes a message, may be a message formatted to be easily interpreted by a computer (e.g., a delimited text file, a Microsoft Excel file, etc.), may include information about more than one piece of media content (e.g., more than one different videos that are received from the same remote site), etc

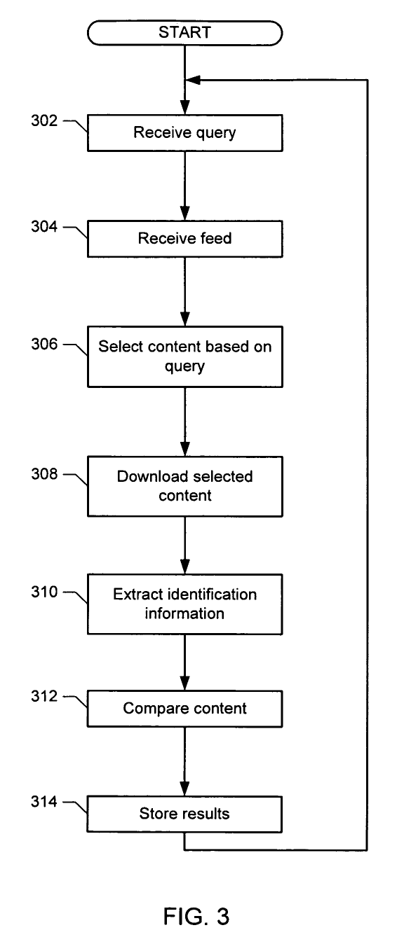

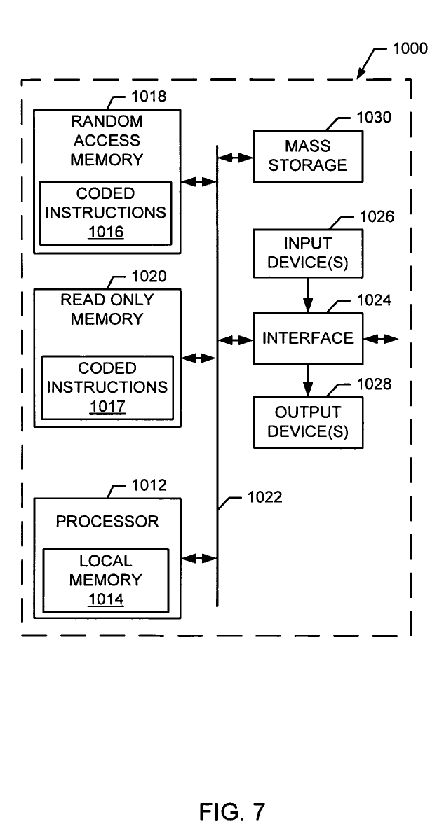

FIGS. 3-5 are flowcharts representative of example machine readable instructions that may be executed to implement the site monitor 110 of FIG. 1 and/or the query builder 202, the feed reader 204, the feed processor 206, the content downloader 208, the content receiver 210, the content processor 212, the datastore 214, the metric generator 216, and/or the notifier 218 of FIG. 2. The example machine readable instructions of FIGS. 3-5 may be executed by a processor, a controller, and/or any other suitable processing device. For example, the example machine readable instructions of FIGS. 3-5 may be embodied in coded instructions stored on a tangible medium such as a flash memory, or random access memory (RAM) associated with a processor (e.g., the processor 1012 shown in the example processor platform 1000 and discussed below in conjunction with FIG. 7). Alternatively, the example flowcharts of FIGS. 3-5 may be implemented using an application specific integrated circuit (ASIC), a programmable logic device (PLD), a field programmable logic device (FPLD), discrete logic, hardware, firmware, etc. In addition, the example flowcharts of FIGS. 3-5 may be implemented manually or as combinations of any of the foregoing techniques. For example, any or all of the site monitor 110 of FIG. 1 and/or the query builder 202, the feed reader 204, the feed processor 206, the content downloader 208, the content receiver 210, the content processor 212, the datastore 214, the metric generator 216, and the notifier 218 of FIG. 2 may be implemented by a combination of firmware, software, and/or hardware. Further, although the example site monitor 110 is implemented by executing the example machine readable instructions represented by the flowcharts of FIGS. 3-5, many other methods of implementing instructions represented by FIGS. 3-5 may be employed. For example, the order of execution of the blocks may be changed, and/or some of the blocks described may be changed, eliminated, sub-divided, and/or combined. Additionally, the example machine readable instructions of FIGS. 3-5 may be carried out sequentially and/or carried out in parallel by, for example, separate processing threads, processors, devices, circuits, etc.

FIG. 3 is a flowchart representative of example machine readable instructions that may be executed to implement the site monitor 110 of FIGS. 1 and 2. The flowchart of FIG. 3 begins when the query builder 202 of the site monitor (e.g., the site monitor 110 of FIG. 1) receives a query from a user (block 302). The feed reader 204 of the site monitor 110 then sends a request to the remote site specified by the user and/or to a set of remote sites specified by the user or otherwise identified (e.g., a predetermined set of remote sites) and receives a content feed from the specified remote site(s) (e.g., the feed reader 204 of FIG. 2 receives a content feed from the remote site 102 and/or the remote site 104 of FIG. 1) (block 304). Alternatively, to request the feed in response to the query, the content feed may have been previously requested and/or subscribed-to and/or may have been requested and/or subscribed-to by a third party.

The feed processor 206 of the site monitor 110 then extracts reference(s) to media content from the content feed corresponding to media content associated with the received query (block 306). For example, the feed processor 206 of FIG. 2 may analyze a title or description included with the reference to the media content to determine if the media content is associated with the received query. The content downloader 208 of the site monitor 110 then downloads the selected media content (block 308). The content receiver 210 subsequently receives the media content requested by the content downloader 208. The content processor 212 of the site monitor 110 then extracts and/or generates identification information (e.g., a code, a signature, etc.) from the downloaded media content (block 310). The content processor 212 of the site monitor 110 compares the extracted identification information to identification information associated with reference media content to determine the identity of the media content (i.e., by determining whether the identifying data of the downloaded media content substantially matches the identifying data of the reference media content and, if so, identifying the media content as the reference media content) (block 312). The content processor 212 of the site monitor 110 then stores the identifying information and/or the result of the comparison in a datastore (e.g., the datastore 214 of FIG. 2) (block 314).

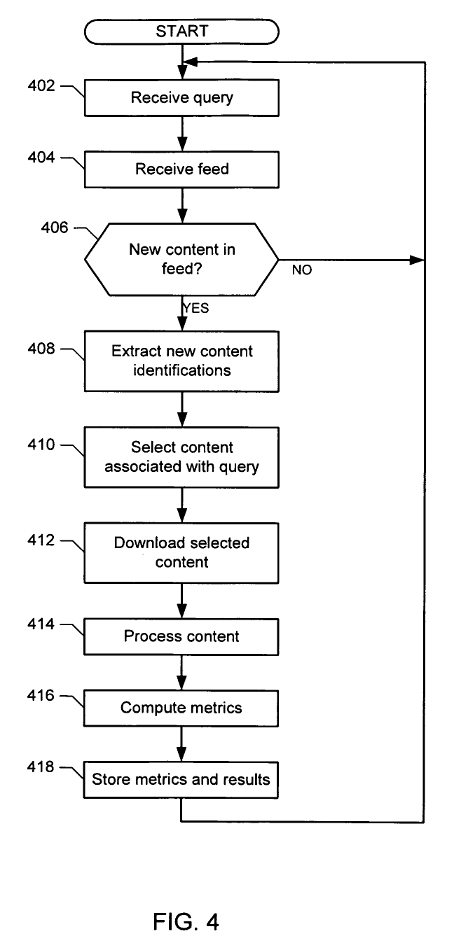

FIG. 4 is a flowchart representative of example machine readable instructions that may be executed to implement the site monitor 110 of FIGS. 1 and 2. Unlike the machine readable instructions of FIG. 3, the machine readable instructions of FIG. 4 are structured to determine if a content feed identifies new media content (e.g., media content that has not previously been processed). The flowchart of FIG. 4 begins when the query builder 202 of the site monitor 110 of FIG. 1 receives a query from a user via the query builder 202 (block 402). The feed reader 204 of the site monitor 110 then sends a request to the remote site specified by the user (or to a set of remote sites specified by the user or otherwise identified (e.g., a predetermined set of sites)). The feed reader 204 then receives a content feed from a remote site (e.g., the feed reader 204 of FIG. 2 receives a content feed from the remote site 102 and/or the remote site 104 of FIG. 1) (block 404). Alternatively, to request the feed in response to the query, the content feed may have been previously requested and/or subscribed-to, and/or may have been requested and/or subscribed-to by a third party.

After receiving a content feed, the feed processor 206 of the site monitor 110 determines if the content feed includes media content that has not previously been downloaded and processed (block 406). For example, the feed processor 206 may determine if new content has been uploaded since the last time that the content feed was received. If the content feed does not include any new media content (block 406), control returns to block 402 to await a further query. Alternatively, control may return to block 404 to await a further content feed.

If the content feed includes media content that has not been previously downloaded and analyzed (block 406), the feed processor 206 of the site monitor 110 extracts identification(s) (e.g., addresses or URL(s)) for new media content in the content feed (block 408). The feed processor 206 then selects any piece(s) of the new media content that are associated with the received query (block 410). Next, the content downloader 208 and the content receiver 210 of the site monitor 110 download the identified media content using the extracted identifications (block 412). After receiving the downloaded media content, the content processor 212 of the site monitor 110 processes the media content to determine the identity of the media content (block 414). For example, the content processor 212 of the site monitor 110 may extract and/or generate code(s) and/or signature(s) from the media content and may compare the code(s) and/or signature(s) to code(s) and/or signature(s) associated with known media content.

The metric generator 216 of the site monitor 110 then computes metrics using received identification information (block 416). For example, the metric generator 216 may determine the number of unique instances where a particular media content is made available at a remote site, may determine the number of times that media content at a remote site was matched to reference media content, etc. The metric generator 216 stores the metrics and the identifying information in the datastore 214 (block 418). Control then returns to block 402 to await a further query. Alternatively, control may return to block 404 to await a further content feed.

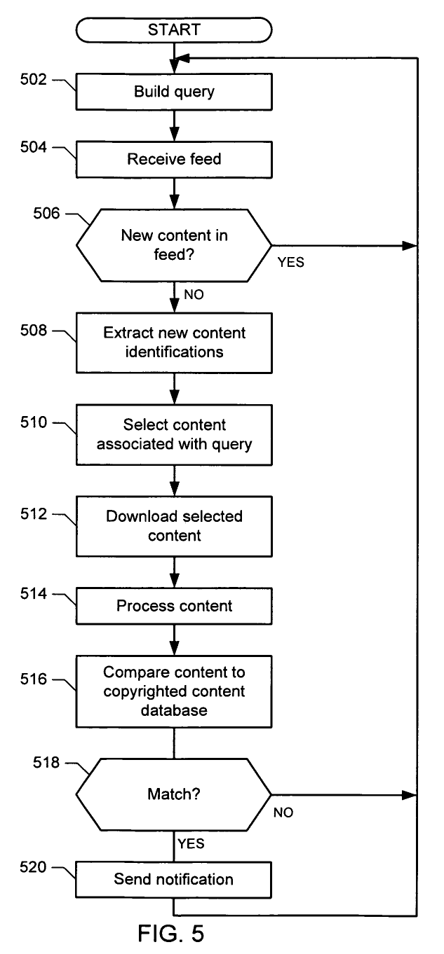

FIG. 5 is a flowchart representative of example machine readable instructions that may be executed to implement the site monitor 110 of FIGS. 1 and 2. Unlike example instructions in FIGS. 3 and 4, the instructions represented by FIG. 5 determine if media content is identified as copyrighted media content and sends a copyright notice. The flowchart of FIG. 5 begins when the query builder 202 of the site monitor 110 of FIG. 1 receives a query from a user via the query builder 202 (block 502). The feed reader 204 of the site monitor 110 then sends a request to the remote site specified by the user (or to a set of remote sites specified by the user or otherwise identified (e.g., a predetermined set of sites)). The feed reader 204 then receives a content feed from a remote site (e.g., the feed reader 204 of FIG. 2 receives a content feed from the remote site 102 and/or the remote site 104 of FIG. 1) (block 504). Alternatively, to request the feed in response to the query, the content feed may have been previously requested and/or subscribed-to, and/or may have been requested and/or subscribed-to by a third party.

After receiving a content feed, the feed processor 206 of the site monitor 110 determines if the content feed includes media content that has not previously been downloaded and processed (block 506). For example, the feed processor 206 may determine if new content has been uploaded since the last time that the content feed was received. If the content feed does not include any new media content (block 506), control returns to block 502 to await a further query. Alternatively, control may return to block 504 to await a further content feed.

If the content feed includes media content that has not been previously downloaded and analyzed (block 506), the feed processor 206 of the site monitor 110 extracts identification(s) (e.g., addresses or URL(s)) for new media content in the content feed (block 508). The feed processor 206 then selects any piece(s) of the new media content that are associated with the received query (block 510). Next, the content downloader 208 and the content receiver 210 of the site monitor 110 download the identified media content using the extracted identifications (block 512). After receiving the downloaded media content, the content processor 212 of the site monitor 110 processes the media content to determine the identity of the media content (block 514). For example, the content processor 212 of the site monitor 110 may extract and/or generate code(s) and/or signature(s) from the media content and may compare the code(s) and/or signature(s) to code(s) and/or signature(s) associated with known media content.

The content processor 212 then compares the extracted identification information to identification information from a database of copyrighted media content (block 516). If the identification information extracted from the media content does not match the identification information associated with copyrighted media content (block 518), control returns to block 502 to await further query information. Alternatively, control may return to block 504 to await a further content feed.

If the identification information extracted from the media content substantially matches the identification information associated with copyrighted media content (block 518), the notifier 218 of the site monitor 110 sends a notification to interested parties (block 520). For example, the site monitor may transmit a copyright notice to the remote site from which the media content was downloaded, a user that uploaded media content to the remote site, a user that viewed media content at the remote site, an owner of the copyright for the media content, and/or a law enforcement entity. Control then returns to block 502 to await a further query. Alternatively, control may return to block 504 to await a further content feed.

FIG. 6 is an illustration of an example content feed file 600. The example content feed file 600 is a “really simple syndication” (RSS) file in XML format. The example content feed file 600 may be received by the site monitor 110 of FIG. 1 to obtain information about media content at the remote site 102 and/or the remote site 104. The example content feed file includes a site section 602, a first item section 604, a second item section 606, and a third item section 608.

The site section 602 of the illustrated example includes a title 610 for a remote site (e.g., the remote site 102 and/or the remote site 104 of FIG. 1), a URL link 612 for the remote site, a description 614 of the remote site, a language 616 for the content feed, a publication date 618 for the content feed, and contact information 620 for a webmaster of the remote site.

The first item section 604, the second item section 606, and the third item section 608 each identify a different piece of media content at the remote site identified in the site section 602. Each of the first item section 604, the second item section 606, and the third item section 608 includes a title 622(a-c) of the media content, a URL link 624(a-c) for the media content, a description 626(a-c) of the media content, a publication date 628(a-c) of the media content, and a URL link 630(a-c) to a source webpage on which the media content can be accessed by users of the remote site.

While the example content feed file 600 includes the forgoing sections and fields, a content field file may include any combination of the forgoing sections and fields and may include any other information associated with a remote site or media content. In addition, while the example content feed file 600 is an XML file, any type of content feed file may be used.

FIG. 7 is a block diagram of an example computer platform 1000 capable of executing the machine readable instructions illustrated in FIGS. 3-5 to implement the site monitor 110 of FIG. 1 and/or the query builder 202, the feed reader 204, the feed processor 206, the content downloader 208, the content receiver 210, the content processor 212, the datastore 214, the metric generator 216, and the notifier 218 of FIG. 2, and/or the other apparatus and/or methods disclosed herein.

The computer platform 1000 of the instant example includes a processor 1012 such as a general purpose programmable processor. The processor 1012 includes a local memory 1014, and executes coded instructions 1016 present in random access memory 1018, coded instruction 1017 present in the read only memory 1020, and/or instructions present in another memory device. The processor 1012 may execute, among other things, the machine readable instructions represented in FIG. 3. The processor 1012 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1012 is in communication with a main memory including a volatile memory 1018 and a non-volatile memory 1020 via a bus 1022. The volatile memory 1018 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1020 may be implemented by flash memory and/or any other desired type of memory device. Access to the main memory 1018, 1020 is typically controlled by a memory controller (not shown) in a conventional manner.

The computer 1000 also includes a conventional interface circuit 1024. The interface circuit 1024 may be implemented by any type of well known interface standard, such as an Ethernet interface, a universal serial bus (USB), and/or a third generation input/output (3GIO) interface.

One or more input devices 1026 are connected to the interface circuit 1024. The input device(s) 1026 permit a user to enter data and commands into the processor 1012. The input device(s) can be implemented by, for example, a keyboard, a mouse, a touchscreen, a track-pad, a trackball, isopoint and/or a voice recognition system.

One or more output devices 1028 are also connected to the interface circuit 1024. The output devices 1028 can be implemented, for example, by display devices (e.g., a liquid crystal display, a cathode ray tube display (CRT), a printer and/or speakers). The interface circuit 1024, thus, typically includes a graphics driver card.

The interface circuit 1024 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1000 also includes one or more mass storage devices 1030 for storing software and data. Examples of such mass storage devices 1030 include floppy disk drives, hard drive disks, compact disk drives and digital versatile disk (DVD) drives.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method comprising:
requesting a really simple syndication (RSS) feed file associated with a received topic identification;
receiving the RSS feed file identifying a first media content;
extracting a first resource identifier for the first media content from the RSS feed file;
retrieving the first media content using the first resource identifier;
at least one of extracting a first content identification code from the first media content and generating a first signature for the first media content; and
storing at least one of the first content identification code and the first signature in a memory.

2. A method as defined in claim 1, further comprising comparing at least one of the first content identification code and the first signature to at least one of a code and a first signature associated with a reference media content.

3. A method as defined in claim 2, further comprising storing an identification of the first media content when at least one of the first content identification code and the first signature matches at least one of the code and the first signature associated with the reference media content.

4. A method as defined in claim 2, further comprising sending a notification indicating that the first media content is a substantial copy of the reference media content to at least one of a copyright owner of the reference content, a distributer of the first media content, a copyright enforcement entity, and a media content ratings provider when at least one of the first content identification code and the first signature matches at least one of the code and the first signature associated with the reference media content.

5. A method as defined in claim 1, wherein the RSS feed file identifies a second media content, the method further comprising:
extracting a second resource identifier for the second media content from the RSS feed file;
retrieving the second media content using the second resource identifier;
at least one of extracting a second content identification code from the second media content and generating a second signature for the second media content; and
storing at least one of the second content identification code and the second signature in a memory.

6. A method as defined in claim 1, wherein the RSS feed file is an extensible markup language file.

7. A method as defined in claim 1, wherein the first media content is a video.

8. A method as defined in claim 1, wherein the RSS feed file is received from a server on the Internet.

9. A method as defined in claim 8, wherein the first media content is downloaded from the server.

10. A method as defined in claim 8, wherein the first media content is downloaded from a content server different from a server that provided the RSS feed file.

11. A method as defined in claim 1, wherein the RSS feed file identifies a second media content, the method further comprising:
extracting a text associated with the second media content;
determining if the text identifies the received topic identification; and
retrieving the second media content when the text identifies the topic identification.

12. An apparatus comprising:
a feed reader to request a really simply syndication (RSS) feed file associated with a received topic identification and to receive the RSS feed file identifying a first media content;
a feed processor to extract a first resource identifier for the first media content from the RSS feed file;
a content downloader to retrieve the first media content using the first resource identifier;
a content processor to at least one of extract a first content identification code from the first media content and generate a first signature for the first media content; and
a datastore to store at least one of the first content identification code and the first signature.

13. An apparatus as defined in claim 12, wherein the content processor is further to compare at least one of the first content identification code and the first signature to at least one of a code and a first signature associated with a reference media content.

14. An apparatus as defined in claim 13, wherein the datastore is further to store an identification of the first media content when at least one of the first content identification code and the first signature matches at least one of the code and the first signature associated with the reference media content.

15. An apparatus as defined in claim 13, further comprising a notifier to send a notification indicating that the first media content is a substantial copy of the reference media content to at least one of a copyright owner of the reference content, a distributer of the first media content, a copyright enforcement entity, and a media content ratings provider when at least one of the first content identification code and the first signature matches at least one of the code and the first signature associated with the reference media content.

16. An apparatus as defined in claim 12, wherein the RSS feed file identifies a second media content, the feed processor is further to extract a second resource identifier for the second media content from the RSS feed file, the content downloader is further to retrieve the second media content using the second resource identifier, the content processor is further to at least one of extract a second content identification code from the second media content and generate a second signature for the second media content, and the datastore is further to store at least one of the second content identification code and the second signature.

17. An apparatus as defined in claim 12, wherein the RSS feed file is an extensible markup language file.

18. An apparatus as defined in claim 12, wherein the first media content is a video.

19. An apparatus as defined in claim 12, wherein the RSS feed file is received from a server on the Internet.

20. An apparatus as defined in claim 19, wherein the first media content is downloaded from the server.

21. An apparatus as defined in claim 19, wherein the first media content is downloaded from a content server different from a server that provided the RSS feed file.

22. An apparatus as defined in claim 12, wherein the RSS feed file identifies a second media content, the feed processor is further to extract a text associated with the second media content and determine if the text identifies the received topic identification, and the content retriever is further to retrieve the second media content when the text identifies the topic identification.

23. A machine readable medium having instructions stored thereon that, when executed, cause a machine to:
request a really simply syndication (RSS) feed file associated with a received topic identification;
receive the RSS feed file identifying a first media content;
extract a first resource identifier for the first media content from the RSS feed file;
retrieve the first media content using the first resource identifier;
at least one of extract a first content identification code from the first media content and generate a first signature for the first media content; and
store at least one of the first content identification code and the first signature in a memory.

24. A machine readable medium as defined in claim 23, wherein the instructions further cause the machine to compare at least one of the first content identification code and the first signature to at least one of a code and a first signature associated with a reference media content.

25. A machine readable medium as defined in claim 24, wherein the further cause the machine to store an identification of the first media content when at least one of the first content identification code and the first signature matches at least one of the code and the first signature associated with the reference media content.

26. A machine readable medium as defined in claim 24, wherein the instructions further cause the machine to send a notification indicating that the first media content is a substantial copy of the reference media content to at least one of a copyright owner of the reference content, a distributer of the first media content, a copyright enforcement entity, and a media content ratings provider when at least one of the first content identification code and the first signature matches at least one of the code and the first signature associated with the reference media content.

27. A machine readable medium as defined in claim 23, wherein the RSS feed file identifies a second media content and the instructions further cause the machine to:
extract a second resource identifier for the second media content from the RSS feed file;
retrieve the second media content using the second resource identifier;
at least one of extract a second content identification code from the second media content and generate a second signature for the second media content; and
store at least one of the second content identification code and the second signature in a memory.

28. A machine readable medium as defined in claim 23, wherein the RSS feed file is an extensible markup language file.

29. A machine readable medium as defined in claim 23, wherein the first media content is a video.

30. A machine readable medium as defined in claim 23, wherein the RSS feed file is received from a server on the Internet.

31. A machine readable medium as defined in claim 30, wherein the first media content is downloaded from the server.

32. A machine readable medium as defined in claim 30, wherein the first media content is downloaded from a content server different from a server that provided the RSS feed file.

33. A machine readable medium as defined in claim 23, wherein the RSS feed file identifies a second media content and the instructions further cause the machine to:
extract a text associated with the second media content;
determine if the text identifies the received topic identification; and
retrieve the second media content when the text identifies the topic identification.

34-63. (canceled)
